(19) United States
(12) Patent Application Publication
(10) Pub. No.: US 2025/0167263 A1
(43) Pub. Date: May 22, 2025

(54) HEAT MANAGEMENT SYSTEM FOR A FUEL CELL BATTERY

(71) Applicants: HYUNDAI MOTOR COMPANY, Seoul (KR); KIA CORPORATION, Seoul (KR)

(72) Inventors: Ki Chul Shin, Seoul (KR); Jae Hyeon Choi, Incheon (KR)

(73) Assignees: HYUNDAI MOTOR COMPANY, Seoul (KR); KIA CORPORATION, Seoul (KR)

(21) Appl. No.: 18/631,764

(22) Filed: Apr. 10, 2024

(30) Foreign Application Priority Data
Nov. 20, 2023 (KR) 10-2023-0160009

(51) Int. Cl. H01M 8/04029; B60R 16/033; H01M 8/04007; H01M 8/04746; H01M 8/1004; H01M 8/2483

(52) U.S. Cl. CPC H01M 8/04029; B60R 16/033; H01M 8/04067; H01M 8/04768; H01M 8/1004; H01M 8/2483; H01M 2250/20

(57) ABSTRACT

A heat management system for the fuel cell battery includes: a fuel cell stack comprising a plurality of fuel cells stacked on one another, and an external cooling passage provided around the outer circumference of the fuel cell stack and configured to allow a cooling water to flow therethrough.

### CROSS-REFERENCE TO RELATED APPLICATION

This application claims, under 35 U.S.C. § 119(a), the benefit of and priority to Korean Patent Application No. 10-2023-0160009, filed on Nov. 20, 2023, the entire contents of which are incorporated herein by reference.

### TECHNICAL FIELD

The present disclosure relates to a fuel cell battery. More particularly, it relates to a heat management system for a fuel cell battery.

### BACKGROUND

A fuel cell battery may generate electric energy through an electrochemical reaction between a fuel and an oxidizing agent. A fuel cell battery is an energy source which does not emit harmful substance. For this reason, research on fuel cell batteries has been actively conducted recently owing to their environmentally friendly aspects. For example, there is a polymer electrolyte fuel cell battery using hydrogen as a fuel and a polymer membrane permeable to hydrogen ions as an electrolyte. The polymer electrolyte fuel cell battery has advantages, such as relatively low operating temperature and high energy conversion efficiency, thereby being adopted in various fields, such as an electric power device for a vehicle.

The fuel cell system includes a fuel cell stack comprising a plurality of fuel cells configured to generate electric energy through an electrochemical reaction between hydrogen as a fuel and oxygen as an oxidizer, a hydrogen supplier configured to supply hydrogen to the fuel cell stack, an air supplier configured to supply air containing oxygen to the fuel cell stack, a heat management system configured to control the operating temperature of the fuel cell battery, and a controller configured to handle the overall control of the fuel cell battery.

Heat management of the fuel cell system may be carried out using cooling water circulating in the fuel cell system. Specifically, the cooling water may flow through the fuel cell stack with a temperature adjusted to satisfy a required temperature condition. Heat is generated due to the electrochemical reaction in the fuel cell stack, and the generated heat needs to be cooled to prevent increase in temperature of the fuel cell stack. During a cold start, the temperature of the fuel cell stack must be quickly increased. When the fuel cell stack is not controlled to an appropriate temperature, differences may arise in terms of water discharge, fuel cell durability, and performance. Therefore, heat management of the fuel cell stack plays a very important role in operating the fuel cell battery.

The above information disclosed in this Background section is provided only enhance understanding of the background of the present disclosure, and therefore it may contain information that does not form the prior art that is already known to one having ordinary skill in the art.

### SUMMARY

The present disclosure has been made in an effort to solve the above-described problems associated with the prior art, and it is an object of the present disclosure to provide a heat management system for a fuel cell battery capable of effectively carrying out heat management for the fuel cell battery.

The object of the present disclosure is not limited to the foregoing, and other objects not mentioned herein should be clearly understood by one having ordinary skill in the art to which the present disclosure pertains based on the description below.

The features of the present disclosure to achieve the object of the present disclosure as described above and perform the characteristic functions of the present disclosure to be described later are as follows.

In one aspect, the present disclosure provides a heat management system for a fuel cell battery, the system including a fuel cell stack comprising a plurality of fuel cells stacked, and an external cooling passage provided around the outer circumference of the fuel cell stack and configured to allow a cooling water to flow therethrough.

In another aspect, the present disclosure provides a heat management system for a fuel cell battery. The heat management system includes: a radiator disposed in heat exchange relationship with cooling water; a first loop including a pump configured to allow the cooling water to flow, and configured to circulate the cooling water; a first valve configured to direct the cooling water passing through the radiator to the first loop; and a second loop configured to circulate the cooling water therein, and including a fuel cell stack disposed in heat exchange relationship with the cooling water. The heat management system further includes: a second valve configured to bring the first loop and the second loop into fluid communication with each other; and a controller configured to control the operations of the pump, first valve, and second valve. In particular, the fuel cell stack includes an external cooling passage provided around the outer circumference of the fuel cell stack and configured to allow the cooling water to flow therethrough, and an internal cooling passage configured to allow the cooling water to flow inside the fuel cell stack.

Other aspects and embodiments of the present disclosure are discussed below.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure should now be described in detail with reference to certain embodiments thereof illustrated in the accompanying drawings which are given hereinbelow by way of illustration only, and thus are not limitative of the present disclosure, and wherein:

FIG. 1 is a schematic view of a fuel cell;

FIG. 2 is a perspective view illustrating a fuel cell stack according to an embodiment of the present disclosure;

FIGS. 3-4 are cross-sectional views of a fuel cell stack according to various embodiments of the present disclosure;

FIGS. 5-9 are perspective views illustrating a fuel cell stack according to various embodiments of the present disclosure; and

FIGS. 10-15 are block diagrams respectively illustrating a heat management system for a fuel cell battery according to various embodiments of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, should be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It should be understood that, when a component is referred to as being “connected to” or “brought into contact with” another component, the component may be directly connected to or brought into contact with the other component, or intervening components may also be present. In contrast, when a component is referred to as being “directly connected to” or “directly brought into contact with” another component, there is no intervening component present. Other terms used to describe relationships between components should be interpreted in a like fashion (e.g., “between” versus “directly between,” “adjacent” versus “directly adjacent,” etc.). When a component, device, element, or the like of the present disclosure is described as having a purpose or performing an operation, function, or the like, the component, device, or element should be considered herein as being “configured to” meet that purpose or to perform that operation or function.

Throughout the present disclosure, like reference numerals indicate like components. The terminology used herein is for the purpose of illustrating embodiments and is not intended to limit the present disclosure. In the present disclosure, the singular form includes the plural sense, unless specified otherwise. The terms “comprises” and/or “comprising” used in the present disclosure mean that the cited component, step, operation, and/or element does not exclude the presence or addition of one or more of other components, steps, operations, and/or elements.

Hereinafter, the present disclosure is described in detail with reference to the accompanying drawings.

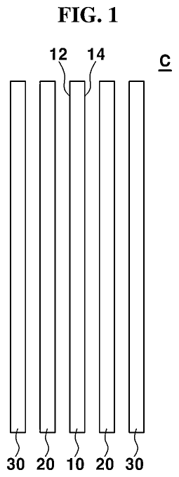

As illustrated in FIG. 1, a fuel cell “C” includes a membrane electrode assembly 10, gas diffusion layers 20, and separator plates 30. The membrane electrode assembly 10 has opposite surfaces on which a cathode 12 and an anode 14 are disposed, respectively. The cathode 12 and the anode 14, in which an electrochemical reaction between hydrogen and oxygen, which are reaction gases, occurs, are each attached to a corresponding one of the opposite sides of an electrolyte membrane of the membrane electrode assembly 10, e.g., a polymer electrolyte membrane.

The gas diffusion layers 20 are disposed on the cathode 12 and the anode 14, respectively. The gas diffusion layers 20 serve to evenly distribute the reaction gases and transmit a generated electric energy.

The separator plates 30 are each disposed at the outermost portion of the fuel cell C. Specifically, one of the separator plates 30 is disposed adjacent to the gas diffusion layer 20 on the cathode 12 side, and the other one of the separator plates 30 is disposed adjacent to the gas diffusion layer 20 on the anode 14 side. The separation plates 30 serve to move the reaction gases and cooling water.

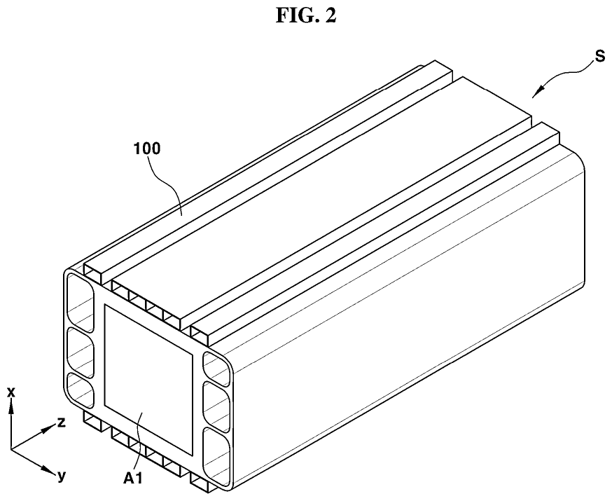

As illustrated in FIG. 2, a fuel cell stack “S” is an electricity-generating assembly including a plurality of fuel cells illustrated in FIG. 1. The fuel cell stack S comprises a plurality of fuel cells C stacked in a stacking direction (z-axis direction). The number of fuel cells C stacked to constitute the fuel cell stack S may be determined based on a required output voltage.

When electric energy is generated by the electrochemical reaction between hydrogen and oxygen occurred in each fuel cell C, heat and water are generated as by-products. For this reason, the fuel cell system includes a heat management system configured to perform cooling using a cooling medium. For example, the cooling medium may be cooling water that circulates through the fuel cell stack S.

The heat management system for the fuel cell battery according to the present disclosure may circulate cooling water through both the outside and inside of the fuel cell stack S.

To this end, according to an embodiment of the present disclosure, the fuel cell stack S includes an external cooling passage 100. The external cooling passage 100 is configured to circulate cooling water, thereby exchanging heat with the fuel cell stack S through the cooling water. The external cooling passage 100 of the fuel cell stack S may be provided on at least a portion of or all over the external circumferential surface of the fuel cell stack S. With this structure, the external cooling passage 100 may cool the fuel cell stack S from the outside, and particularly, the temperature of a supply manifold and a discharge manifold adjacent to the outside air may be freely controlled.

In one implementation, the external cooling passage 100 may be integrated with the fuel cell stack S. For example, the external cooling passage 100 may be formed on one separator plate 30 by molding and injection. Because the external cooling passage 100 may be adjusted in length, the length of the external cooling passage 100 may be determined considering the number of the separator plates 30 included in the fuel cell stack S. In another implementation, the external cooling passage 100 may be provided separately from the fuel cell stack S and be detachably assembled to the external circumferential surface of the fuel cell stack S.

According to one embodiment of the present disclosure, the fuel cell stack S includes an internal cooling passage 110. The internal cooling passage 110 allows the cooling water to circulate inside the fuel cell stack S. The internal cooling passage 110 may be provided between every two neighboring fuel cells in the fuel cell stack S. Specifically, assuming that a first fuel cell and a second fuel cell are disposed adjacent to each other in the fuel cell stack S, the cooling water may flow through the internal cooling passage 110 formed by the anode side separator plate of the first fuel cell and the cathode side separator plate of the second fuel cell. In the present disclosure, the external cooling passage is a flow passage of cooling water provided on the external circumferential surface of the fuel cell stack S, and the internal cooling passage 110 is a flow passage of cooling water provided inside the fuel cell stack S.

As such, in order to direct the cooling water into the fuel cell stack S and discharge the cooling water from the fuel cell stack S, the separator plate 30 includes a supply manifold and a discharge manifold, as illustrated in FIG. 3. Here, the respective position of the supply manifold and the discharge manifold may change, differently from the drawing. The supply manifold may supply the cooling water to the internal cooling passage 110 through a cooling water supply portion 33 The cooling water flowing through the internal cooling passage 110 through a cooling water discharge portion 36 may be discharged outside the fuel cell stack S. Moreover, the supply manifold includes a hydrogen supply portion 31 and an air supply portion 32 configured to supply hydrogen and air into the fuel cell stack S, respectively. The discharge manifold includes a hydrogen discharge portion 34 and an air discharge portion 35 configured to discharge hydrogen and air outside the fuel cell stack S, respectively. Furthermore, as illustrated in the drawing, a gasket may be disposed on the separation plate 30 to seal fluids flowing through the supply manifold, the discharge manifold or the external cooling passage 100.

When the fuel cell stack S is cooled only through the internal cooling passage, a temperature difference may occur between the fuel cells due to the shape of the internal cooling passage 110 and may also occur within one fuel cell. According to the present disclosure, by further including the external cooling passage 100 in addition to the internal cooling passage, the temperature difference between fuel cells and the temperature difference within one fuel cell may be reduced. Moreover, according to the present disclosure, the temperature of the fuel cell stack S may be quickly increased even during cold starting.

Continuing to refer to FIG. 3, according to an embodiment of the present disclosure, the external cooling passage 100 may include a plurality of passages that are separated from each other to allow cooling water to flow independently of each other. The plurality of passages 100 may be arranged on the external circumferential surface of the fuel cell stack. As described below, the cooling water may be selectively supplied to each passage of the external cooling passage 100. Due to the design limitations of the internal cooling passage 110 and based on the principles of reaction gas supply and water management, differences in temperature may occur depending on the position thereof within the fuel cell stack. According to the present disclosure, with selective flow control of the cooling water through the external cooling passage 100, high-temperature cooling water may be circulated to a portion of the fuel cell stack at a relatively low temperature, and low-temperature cooling water may be circulated to a portion of the fuel cell stack at a relatively high temperature. Therefore, such a layout design of the external cooling passage 100 may enable effective temperature management for each portion of the fuel cell stack.

The position of the external cooling passage 100 in the fuel cell stack S may be determined based on the temperature of the fuel cell stack S. For example, some passages of the external cooling passage 100 may be disposed to be spaced apart from the other passages. In some implementations, some passages of the external cooling passage 100 may be disposed to be brought into contact with each other. Portions generally at a high temperature and portions generally at a low temperature in the fuel cell stack S may be determined using a temperature analyzer, whereby the external cooling passage 100 may be disposed at the determined position.

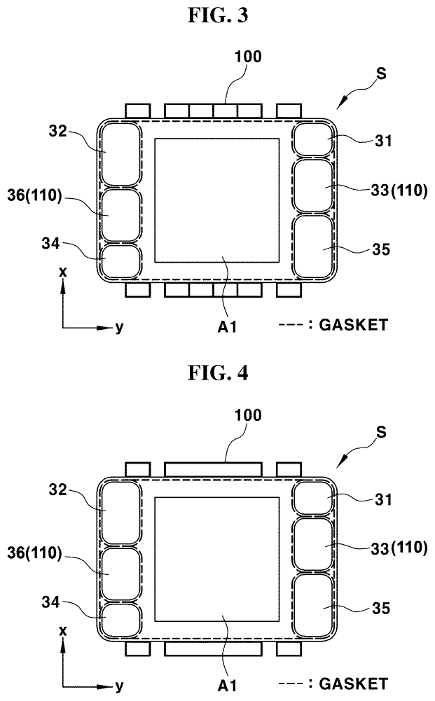

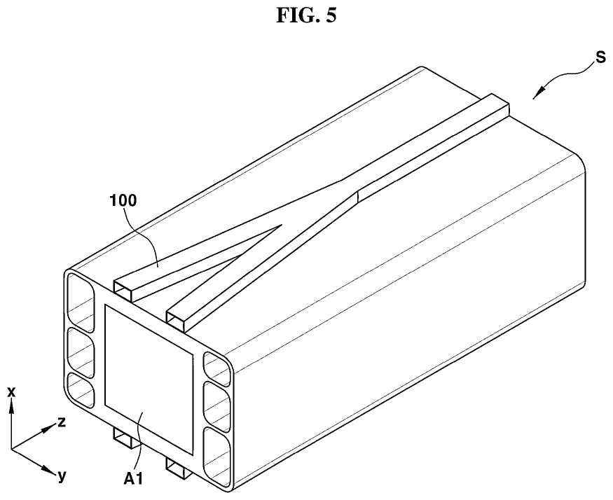

Referring to FIG. 4, according to some embodiments of the present disclosure, there is no limit to the shape of the external cooling passage 100. For example, the cross-sectional area of the external cooling passage 100 may be adjusted. As in the illustrated example, the cross-sectional area of the external cooling passage 100 may be increased to have a length of at least half of the length of the major axis direction (i.e., y-axis direction) of the separator plate 30. Conversely, the cross-sectional area may be reduced.

As illustrated in FIG. 5, according to some embodiments of the present disclosure, the cross-sectional area of the external cooling passage 100 changes in the stacking direction (i.e., z-axis direction) of the fuel cell C. The flow rate of cooling water may differ for each fuel cell C. Particularly, when the number of the fuel cells C in the fuel cell stack S increases, the difference may get bigger. When the cross-sectional area of the external cooling passage 100 changes in the stacking direction (z-axis direction), the non-uniform flow rate of cooling water may be adjusted. For example, for the fuel cell C into which a less amount of cooling water is introduced from the separator plate 30, the amount of cooling water may be increased by increasing the cross-sectional area of the external cooling passage 100.

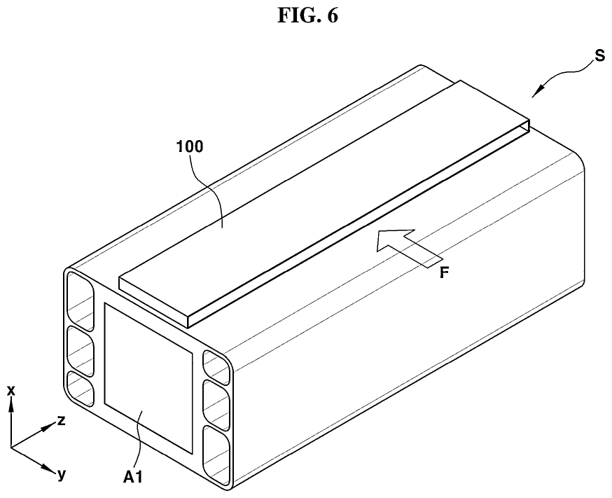

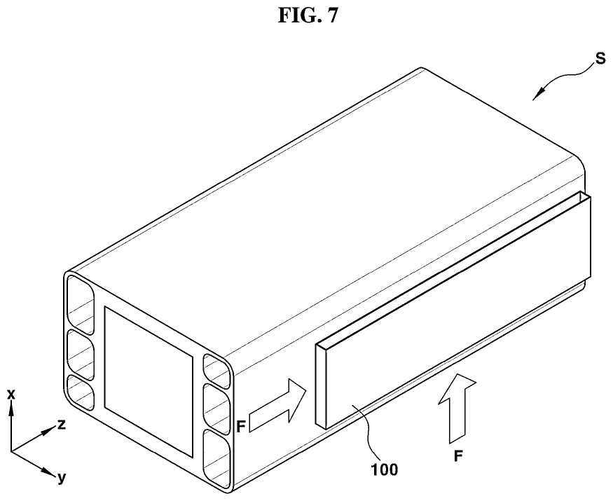

Referring to FIG. 6, in some embodiments of the present disclosure, the cooling water directed to the external cooling passage 100 may be directed in a direction different from the stacking direction (z-axis direction), e.g., in a supply direction F. In this case, the cross-sectional area of the external cooling passage 100 is greatly increased, rapidly decreasing the differential pressure of the cooling water and facilitating temperature control. Particularly, it is advantageous in a cold start condition when cooling water is supplied to the external cooling passage 100 in the supply direction F. Due to the nature of the coupling structure of the fuel cell stack, in a cold start condition where the temperature is low, the temperature is increased by operating heaters at the end cells positioned at opposite end of the fuel cell stack S, respectively. In this case, the temperature of the end cells quickly increases, but the temperature of the fuel cell C disposed in the middle of the fuel cell stack S slowly increases. However, when the cooling water is supplied to the external cooling passage 100 in the supply direction F, substantially perpendicular to the stacking direction (z-axis direction), this may speed up the temperature rise at the cell disposed in the middle the fuel cell stack S. However, the shape and position of the external cooling passage 100 are not limited to the illustrated example, and the length and position of the external cooling passage 100 may be adjusted according to the temperature control strategy.

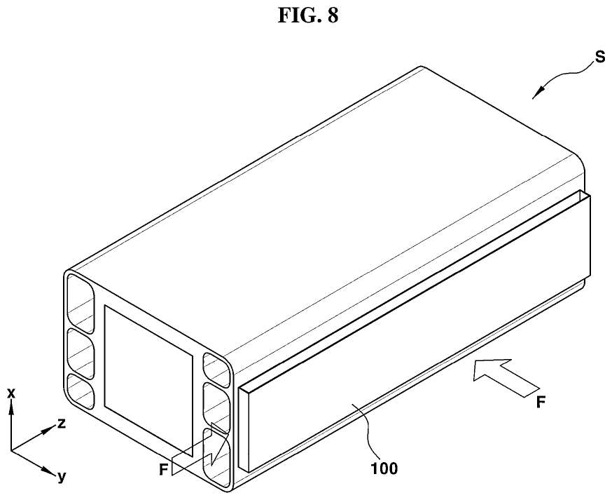

Referring to FIG. 7, according to some embodiments of the present disclosure, the external cooling passage 100 may be disposed on a surface adjacent to the supply manifold or the discharge manifold. The supply manifold or the discharge manifold contacts the air outside the fuel cell stack S, so the same may easily lose heat not only under a cold start condition but also under a normal driving condition. However, because heat management is not carried out in the manifolds, it is hard to assume that cooling water at an appropriate temperature is being supplied into the fuel cell stack S. Under temperature rise condition, cooling water at a relatively high temperature is supplied at the cooling water supply portion 33 side, whereas cooling water at a relatively low temperature is supplied to a portion away from the cooling water supply portion 33. Thus, a temperature difference inevitably occurs for each cell. Therefore, as in the above-described embodiment, the external cooling passage 100 may be disposed on a surface adjacent to the surface in a major side direction (y-axis direction). Additionally, or alternatively, the external cooling passage 100 may be disposed on the surface of the separation plate 30 in a minor axis direction (x-axis direction). In this case, not only the temperature of a reaction area A1 but also the temperature of the manifold may be managed. As illustrated in FIG. 7, the external cooling passage 100 may extend from a portion of the fuel cell stack S or may extend along the entire fuel cell stack S as illustrated in FIG. 8. Moreover, the cooling water may be supplied to the external cooling passage 100 in both supply directions F as illustrated. In other words, the external cooling passage 100 may be disposed on at least one side of the separator plate 30 or may be disposed on all sides of the separator plate 30.

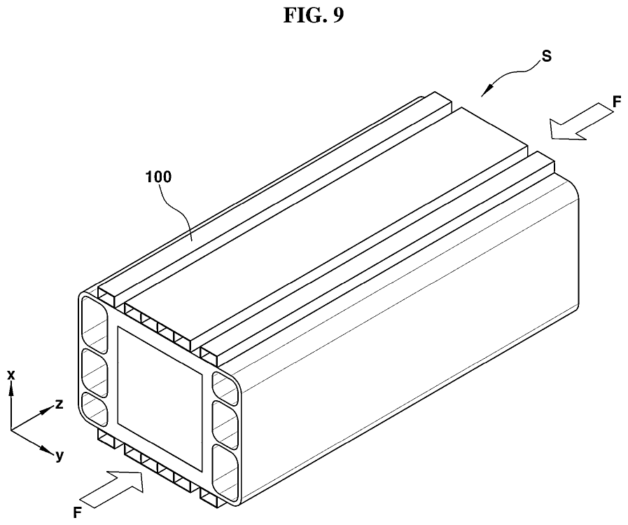

According to some embodiments of the present disclosure, the supply direction F of the cooling water through the external cooling passage 100 may be set differently for each external cooling passage 100. For example, a counter flow may be formed between the external cooling passages 100. As illustrated in FIG. 9, the cooling water may be directed in the supply direction (z-axis direction) in some of the external cooling passages 100, and cooling water may be directed in other portions of the external cooling passages 100 in a supply direction (−z-axis direction). In other words, a plurality of external cooling passages may include: a first external cooling passage configured to receive the cooling water in a first direction (e.g., z-axis direction); and a second external cooling passage configured to receive the cooling water in a second direction (e.g., −z-axis direction) opposite to the first direction. When the cooling water flows only in one direction in the fuel cell stack S, the temperature of the cell increases with increasing distance from the cooling water supply portion 33 when a great amount of heat is generated in the cell. In other words, the temperature of the cell increases as it moves away from the cooling water supply unit 33. As in the illustrated example, when a counter flow is formed in the flow of cooling water flowing through the external cooling passage 100, it may be advantageous in managing the temperature of the entire fuel cell stack S.

According to the present disclosure, by utilizing the external cooling passage 100 to make up for the cooling water space that decreases as the cell pitch decreases within the fuel cell stack, it is possible to reduce the temperature difference within the cell and decrease the differential pressure in cooling water.

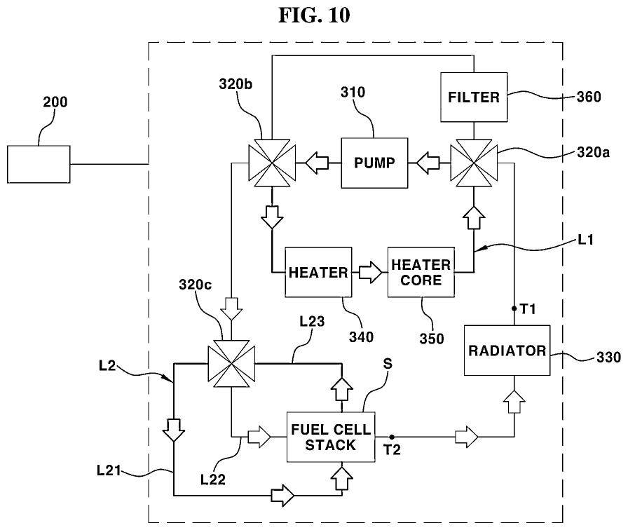

As illustrated in FIG. 10, according to some implementations of the present disclosure, heat management may be carried out using the heat management system for the fuel cell system including the external cooling passage 100 and the internal cooling passage. A controller 200 may control each component of the heat management system for the fuel cell system. For example, the controller 200 may control the operations of pumps 310 and 400, valves 320a, 320b, 320c, and 320d, and a heater 340 of the heat management system.

According to the present disclosure, the heat management system for the fuel cell system includes a first loop L1 and a second loop L2. A cooling water may circulate through the first loop L1 and the second loop L2, and the first loop L1 and the second loop L2 are disposed in heat exchange relationship with the fuel cell stack S. In one implementation, a cooling water in the first loop L1 and a cooling water in the second loop L2 may separately circulate through the fuel cell stack S. In one implementation, the cooling water in the first loop L1 and the cooling water in the second loop L2 may be mixed with each other and circulated through the fuel cell stack S. When needed, the cooling water may circulate to the fuel cell stack S through the first loop L1 and the second loop L2, simultaneously, or may circulate to the fuel cell stack S through at least one of the first loop L1 and or second loop L2. Hereinafter, various embodiments of temperature control of the fuel cell system are described with reference to FIGS. 10 to 15.

A first pump 310 disposed in the first loop L1. The first pump 310 may circulate the cooling water. The first loop L1 may also include a first valve 320a and a second valve 320b. The first valve 320a may direct the cooling water at a temperature decreased by a radiator 330 into the first loop L1. The first valve 320a may also direct the circulating cooling water to a filter 360 configured to filter the cooling water. In some implementations, the first valve 320a may be a four-way valve.

The temperature of the cooling water may be increased through the first loop L1. To this end, the heater 340 is in the first loop L1. The cooling water passing through the heater 340 may be increased in temperature. The second valve 320b may be controlled to direct the cooling water to the heater 340 and a heater core 350 in the first loop L1, increasing the temperature of the cooling water. In some implementations, the second valve 320b may be a four-way valve. The cooling water may be directed to the fuel cell stack S by controlling the second valve 320b.

The cooling water may be supplied from the first loop L1 to the second loop L2 by controlling a third valve 320c. In some implementations, the cooling water circulating through the second loop L2 may flow through the fuel cell stack S separately from the cooling water flowing through the first loop L1. In some implementations, the third valve 320c may be a direction control valve, such as a four-way valve.

As illustrated in FIG. 10, when the temperature of the fuel cell stack S needs to be increased, the cooling water in the first loop L1 may be heated by the heater 340 and be directed to the fuel cell stack S through the third valve 320c. Therefore, the temperature of the fuel cell stack S may be increased by the cooling water circulating in a pipe L22. At the same time, the cooling water heated through the first loop L1 may be directed to a pipe L21 through the third valve 320c. As such, the cooling water through the pipe L21 is also configured to pass the fuel cell stack S, quickly increasing the temperature of the fuel cell stack S.

In some implementations, the cooling water may circulate through other portions of the fuel cell stack S through the first loop L1 and the second loop L2. For example, the cooling water through the pipe L21 may be directed to the external cooling passage 100 of the fuel cell stack S. The cooling water through the pipe L22 may be directed to the internal cooling passage 110 through the cooling water supply portion 33 of the fuel cell stack S. Therefore, according to the present disclosure, the temperatures of the outside and inside of the fuel cell stack S may be increased simultaneously, quickly increasing the temperature of the fuel cell stack S.

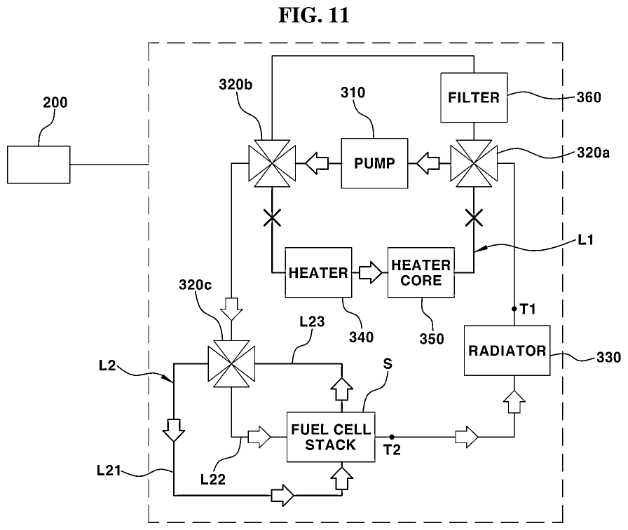

As illustrated in FIG. 11, according to some embodiments of the present disclosure, the fuel cell stack S may be cooled by controlling the flow of the cooling water through the first loop L1 and the second loop L2. The cooling water passing through the radiator 330 has a lower temperature T1 than the temperature T2 of the cooling water passing through the fuel cell stack S under a normal driving condition. In order to cool the fuel cell stack S, the cooling water is directed to the fuel cell stack S by controlling the second valve 320b and the third valve 320c, rather than being directed from the first loop L1 to the heater 340. Therefore, the cooling water at the temperature T1 may be directed to the fuel cell stack S through the pipe L22 to cool the fuel cell stack S.

Moreover, the cooling water at the temperature T1 is directed to the pipe L21 by controlling the third valve 320c, carrying out additional cooling of the fuel cell stack S. As described above, by directing the cooling water to a portion where the temperature is relatively high within the fuel cell stack S, the fuel cell stack S may be cooled quickly and portions where there are temperature differences may be cooled evenly.

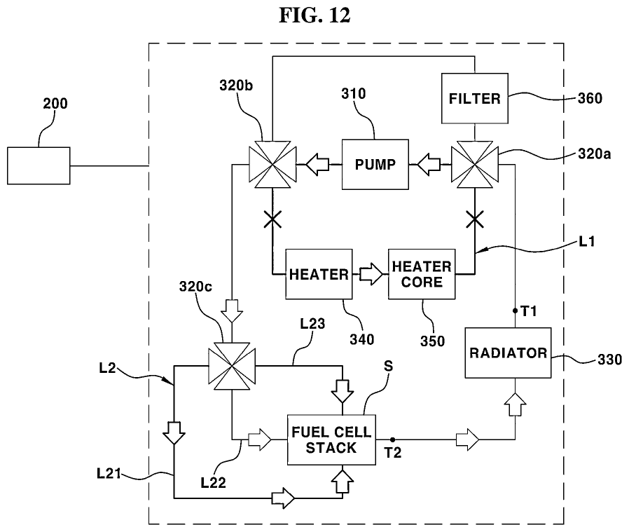

The flow of cooling water through a pipe L23 in FIG. 12 is different from that through the pipe L23 in FIG. 11. According to some embodiments, the cooling water at the low temperature T1 directed to the second loop L2 through the third valve 320c may be directed to the fuel cell stack S through the pipe L21 and pipe L23 and then be discharged from the fuel cell stack S and directed to the radiator 330.

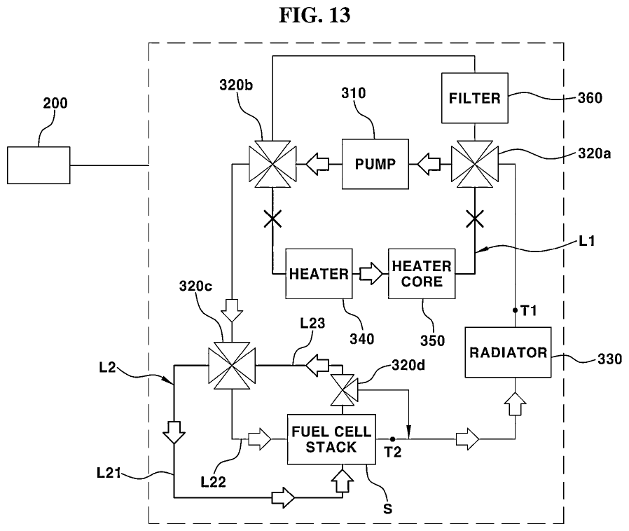

Referring to FIG. 13, according to some embodiments, the second loop L2 may further include a fourth valve 320d. The temperature of the cooling water passing through the fuel cell stack S becomes greater than the temperature T1 of the cooling water. Here, the temperature of the fuel cell stack S may be controlled to be more uniform by once again circulating the cooling water, whose temperature has increased, in a portion of the fuel cell stack S at a relatively low temperature.

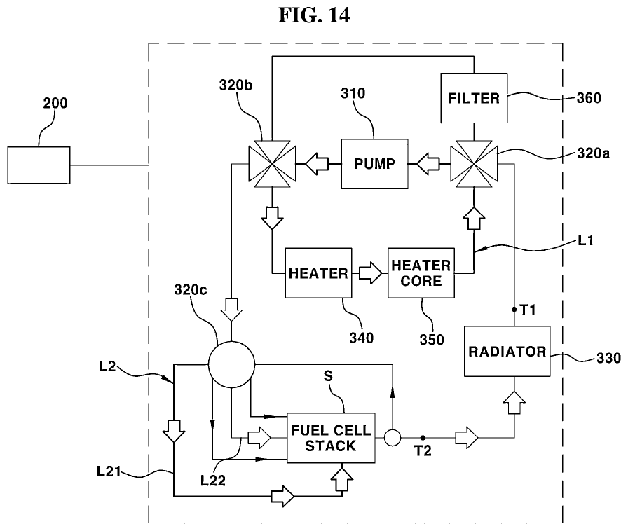

As illustrated in FIG. 14, according to some embodiments of the present disclosure, the third valve 320c may be a distributor. The distributor includes a plurality of channels, and each channel may be opened and closed using a solenoid or the like. Pipes connected to each channel of the distributor are configured to communicate with a predetermined portion of the external cooling passage 100 of the fuel cell stack S and the internal cooling passage 110 of the fuel cell stack S to circulate the cooling water. The cooling water may be flowed to a desired portion of the fuel cell stack S by controlling the distributor to manage the temperature of the fuel cell stack S appropriately.

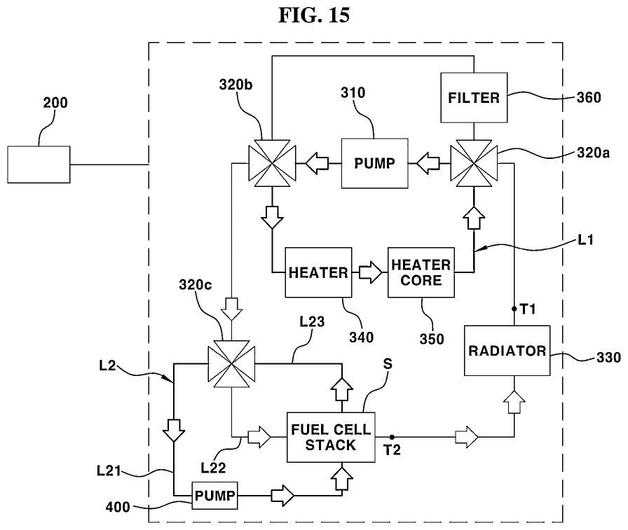

Referring to FIG. 15, the second loop L2 may further include a second pump 400. In this embodiment, the cooling water circulating in the second loop L2 may be operated separately by the second pump 400. Moreover, the cooling water circulating in the second loop L2 may flow more smoothly while the first loop L1 and the second loop L2 are communicable with each other.

In some embodiments, under a cold start condition, the temperature of the fuel cell stack S may be increased through the external cooling passage 100. In this case, the cooling water is circulated to the fuel cell stack S through the external cooling passage 100 before reaching the internal cooling passage. Therefore, the temperature of the fuel cell stack S itself is first increased, and then, when the fuel cell stack S reaches an appropriate temperature, the temperatures of the external cooling passage 100 and the internal cooling passage 110 are increased.

Specifically, the cooling water in the first loop L1 is directed only to the external cooling passage 100 to quickly increase the temperature of the fuel cell stack S itself. In a cold start condition, the fuel cell stack S generally has the highest temperature, the cooling water circulating in the first loop L1 has the next highest temperature, and the outside air in contact with the fuel cell stack S has the lowest temperature. This is because, the cooling water circulating in the first loop L1 must heat not only each part of the fuel cell system but also the pipes interconnecting the parts. Therefore, compared to the temperature increase of the fuel cell stack S itself, the temperature increase of the cooling water circulating in the first loop L1 is delayed and thus the cooling water has a relatively low temperature. Here, when the cooling water circulating in the first loop L1 is directed to the fuel cell stack S, the temperature increase is delayed compared to when only the temperature of the fuel cell stack S is increased. For this reason, in this embodiment, the cooling water in the first loop L1 is directed only to the external cooling passage 100 to more quickly increase the temperature of the fuel cell stack S in contact with the outside air. With this process, by increasing the heat amount of the fuel cell stack S itself, it is possible to increase the overall heat amount. This is because, generally, as the temperature of the fuel cell stack S increases, the heat amount of the fuel cell stack S increases.

As is apparent from the above description, the present disclosure provides the following effect.

The present disclosure provides a heat management system for a fuel cell battery capable of effectively carrying out heat management for the fuel cell battery.

Effects of the present disclosure are not limited to what has been described above, and other effects not mentioned herein should be clearly recognized by those having ordinary skill in the art based on the above description.

It should be apparent to those having ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A heat management system for a fuel cell battery, the heat management system comprising:
a fuel cell stack comprising a plurality of fuel cells stacked on one another; and
an external cooling passage provided around an outer circumference of the fuel cell stack and configured to allow a cooling water to flow therethrough.

2. The heat management system of claim 1, wherein the external cooling passage extends at least partially in a length direction of the fuel cell stack.

3. The heat management system of claim 1, wherein the external cooling passage has a cross-sectional area that changes in a length direction of the fuel cell stack.

4. The heat management system of claim 1, wherein the external cooling passage allows the cooling water to be supplied thereinto in a length direction of the fuel cell stack or in a direction perpendicular to the length direction.

5. The heat management system of claim 1, wherein the external cooling passage has a portion into which the cooling water is supplied in a first direction and has another portion into which the cooling water is supplied in a second direction opposite to the first direction.

6. The heat management system of claim 1, wherein the fuel cell stack comprises an internal cooling passage configured to allow the cooling water to flow inside the fuel cell stack.

7. The heat management system of claim 1, wherein the fuel cell stack comprises:
a membrane electrode assembly;
gas diffusion layers disposed on opposite surfaces of the membrane electrode assembly, respectively; and
separator plates each disposed at an outer side of a corresponding gas diffusion layer of the gas diffusion layers.

8. The heat management system of claim 7, wherein each of the separator plates comprises:
a supply manifold through which air, hydrogen, and a cooling water are supplied; and
a discharge manifold through which the air, hydrogen, and cooling water are discharged.

9. The heat management system of claim 8, wherein the external cooling passage is disposed adjacent to the supply manifold.

10. The heat management system of claim 8, wherein the fuel cell stack comprises an internal cooling passage configured to allow the cooling water introduced through the supply manifold to flow inside the fuel cell stack.

11. A heat management system for a fuel cell battery, the heat management system comprising:
a radiator disposed in heat exchange relationship with a cooling water;
a first loop comprising a pump configured to circulate the cooling water in the first loop;
a first valve configured to direct the cooling water passing through the radiator to the first loop;
a second loop configured to circulate the cooling water therein and comprising a fuel cell stack disposed in heat exchange relationship with the cooling water;
a second valve configured to bring the first loop and the second loop into fluid communication with each other; and
a controller configured to control operations of the pump, the first valve, and the second valve,
wherein the fuel cell stack comprises: an external cooling passage arranged on an outer circumference of the fuel cell stack and configured to allow the cooling water to flow therethrough, and an internal cooling passage configured to allow the cooling water to flow inside the fuel cell stack.

12. The heat management system of claim 11, wherein, in order to cool the fuel cell battery, the controller is configured to control operation of the first valve and the second valve to:
direct the cooling water circulating in one of the first loop and the second loop to the external cooling passage, and
direct the cooling water circulating in a remaining one of the first loop and the second loop to the internal cooling passage.

13. The heat management system of claim 11, wherein the first loop further comprises a heater disposed in heat exchange relationship with the cooling water.

14. The heat management system of claim 13, wherein the controller is configured to, under a cold start condition for the fuel cell battery:
operate the heater;
circulate the cooling water circulating in the first loop and the second loop only through the external cooling passage; and
when the fuel cell stack reaches a predetermined temperature, control the first valve and the second valve to circulate the cooling water to the external cooling passage and to the internal cooling passage.

15. The heat management system of claim 11, wherein the second loop comprises a second pump configured to flow the cooling water circulating in the second loop.

16. A fuel cell battery comprising the heat management system according to claim 1.

17. A vehicle comprising the heat management system according to claim 1.

18. A heat management system for a fuel cell battery, the heat management system comprising:
a fuel cell stack comprising a plurality of fuel cells stacked on one another;
a plurality of external cooling passages arranged on an external circumferential surface of the fuel cell stack and configured to allow a cooling water to flow therethrough; and
an internal cooling passage configured to allow the cooling water to flow inside the fuel cell stack,
wherein the plurality of external cooling passages includes: a first external cooling passage configured to receive the cooling water in a first direction; and a second external cooling passage configured to receive the cooling water in a second direction opposite to the first direction.
